(19) United States
(12) Patent Application Publication
(10) Pub. No.: US 2006/0087236 A1
(43) Pub. Date: Apr. 27, 2006

(54) Plasma display panel

(75) Inventors: Hyun Kim, Suwon-si (KR); Seok-Gyun Woo, Suwon-si (KR)

Correspondence Address: MCGUIREWOODS, LLP, 1750 TYSONS BLVD, SUITE 1800, MCLEAN, VA, 22102, US

(73) Assignee: Samsung SDI Co., Ltd.

(21) Appl. No.: 11/253,644

(22) Filed: Oct. 20, 2005

(30) Foreign Application Priority Data
Oct. 27, 2004 (KR) 10-2004-0086157
Mar. 4, 2005 (KR) 10-2005-0018165

(51) Int. Cl. H01J 17/49

(52) U.S. Cl. 313/582

(57) ABSTRACT

A plasma display panel having an improved exhaust tube structure, through which a discharge gas is re-injected into a space in the plasma display panel, if necessary. The plasma display panel includes first and second substrates that are sealed together, and an exhaust tube that has a plurality of separably coupled hollow bodies. The exhaust tube communicates with an exhaust hole formed in one substrate of the first and second substrates.

### CROSS-REFERENCE TO RELATED APPLICATIONS

This application claims priority to and the benefit of Korean Patent Application No. 10-2004-0086157, filed on Oct. 27, 2004, and Korean Patent Application No. 10-2005-0018165, filed on Mar. 4, 2005, which are hereby incorporated by reference for all purposes as if fully set forth herein.

### BACKGROUND OF THE INVENTION

1. Field of the Invention

The present invention relates to a plasma display panel and, more particularly, to a structure of a plasma display panel's exhaust tube.

2. Discussion of the Background

Recently, the plasma display panel (PDP) has attracted public attention as a large, flat screen display device. Generally, the PDP displays an image using gas discharge generated in discharge cells.

The PDP has a front substrate and a rear substrate that are substantially parallel to each other, like other flat panel displays such as a vacuum fluorescent display (VFD) or a field emission display (FED). The substrates are bonded to each other by an adhesive, which is arranged along the periphery of at least one of the substrates, thereby forming a so-called vacuum tube.

A space between the substrates is exhausted to create a vacuum, and a discharge gas is injected into the space.

Such a PDP may have a shortened life span because a protective film (MgO) is damaged by ion impact, a fluorescent film is damaged by vacuum ultraviolet rays (VUV), or a discharge gas may be contaminated due to impurities caused by the damages or out-gassing generated in materials of other constituents.

Accordingly, in order to prevent contaminated discharge gas, in particular, from shortening the PDP's life span, methods for replacing the discharge gas have been studied.

However, it may be difficult to replace the discharge gas in a conventional PDP structure, and thus the shortening of the PDP's life span due to the discharge gas may not be prevented.

FIG. 8 shows a conventional PDP. Referring to FIG. 8, an exhaust tube 5 is provided on one side of a rear substrate 3 of the PDP 1 to maintain the space in the PDP in a vacuum. The exhaust tube 5 has a unitary structure. Hence, once the end of the exhaust tube 5 is sealed, in order to replace the discharge gas, the entire exhaust tube 5 is removed.

Further, the exhaust tube 5, which is fixed to the rear substrate 3 by a sealing paste 7, is removed by cutting it from the rear substrate 3.

However, the exhaust tube is securely fixed to the rear substrate 3 by the sealing paste 7. The sealing paste 7 is typically made of glass, which is the same material as that of the PDP's rear substrate 3 or front substrate 9.

Accordingly, when the exhaust tube 5 and the sealing paste 7 are separated from the rear substrate 3, the rear substrate 3 may be cracked and damaged.

Therefore, in the conventional PDP, it may be difficult to change the discharge gas due to the exhaust tube's structure.

Further, the exhaust tube 5 protrudes from the rear substrate 3. Accordingly, when mounting a circuit board on a chassis base with the PDP 1 supported and provided thereon, the exhaust tube 5 may interfere with the circuit board, which makes it difficult to mount the circuit board on the chassis base. Furthermore, the exhaust tube 5 itself may be damaged.

Also, with the above-described structure of the exhaust tube 5, the PDP's thickness may not be reduced.

### SUMMARY OF THE INVENTION

The present invention provides a PDP having an improved exhaust tube structure through which discharge gas may easily be re-injected into a space of the PDP, if necessary.

Additional features of the invention will be set forth in the description which follows, and in part will be apparent from the description, or may be learned by practice of the invention.

The present invention discloses a PDP including first and second substrates that are sealed together, and an exhaust tube that has a plurality of separably coupled hollow bodies. The exhaust tube communicates with an exhaust hole formed in one substrate of the first substrate and the second substrate.

The present invention discloses an exhaust tube for a flat panel display. The exhaust tube includes a plurality of separably coupled hollow bodies.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a rear perspective view showing a PDP according to a first exemplary embodiment of the invention.

FIG. 2 is a cross-sectional view taken along line II-II of FIG. 1.

FIG. 3A is a diagram showing a case in which an exhaust tube according to the first exemplary embodiment of the invention is used.

FIG. 3B is a diagram showing a case in which the exhaust tube according to the first exemplary embodiment of the invention is used.

FIG. 3C is a diagram showing a case in which the exhaust tube according to the first exemplary embodiment of the invention is used.

FIG. 4 is a rear perspective view showing a PDP according to a second exemplary embodiment of the invention.

FIG. 5 is a cross-sectional view taken along line V-V of FIG. 4.

FIG. 6 is a rear perspective view showing a PDP according to a modification of the second exemplary embodiment of the invention.

FIG. 7A is a diagram showing a case in which an exhaust tube according to the second exemplary embodiment of the invention is used.

FIG. 7B is a diagram showing a case in which the exhaust tube according to the second exemplary embodiment of the invention is used.

FIG. 7C is a diagram showing a case in which the exhaust tube according to the second exemplary embodiment of the invention is used.

FIG. 8 is a rear perspective view showing a conventional PDP exhaust tube.

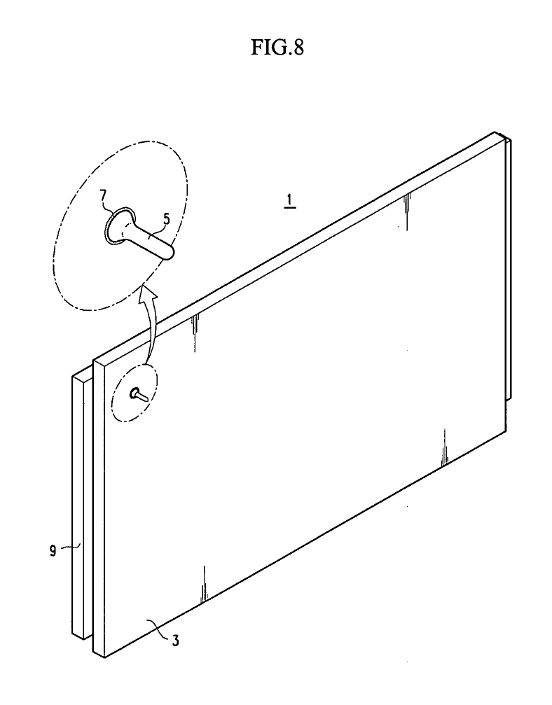

### DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Further, the same elements over the entire description are represented by the same reference numerals.

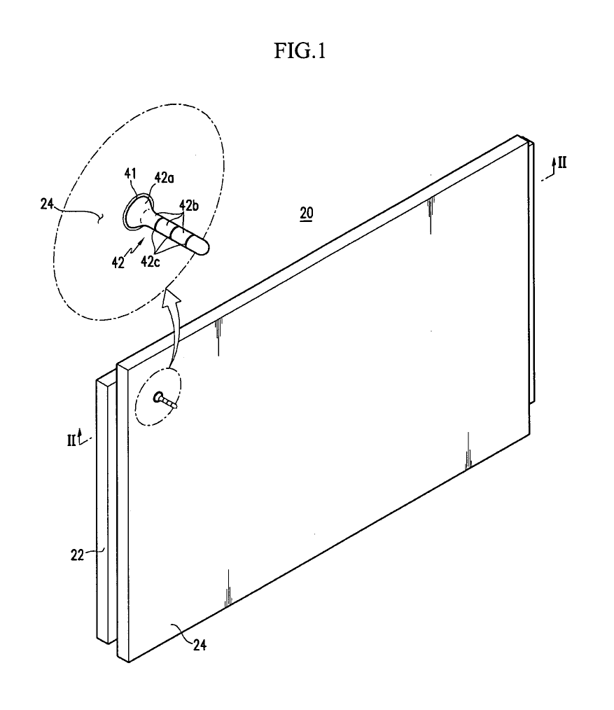

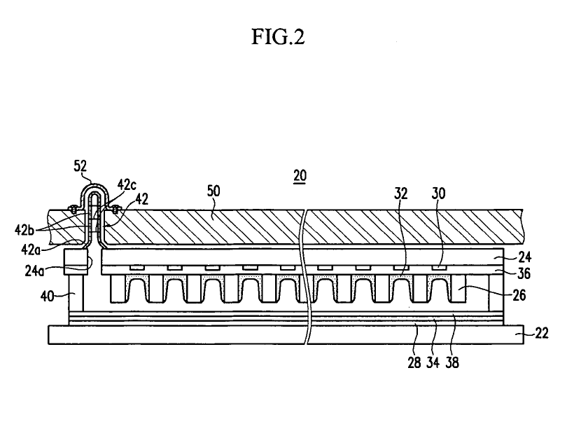

FIG. 1 is a rear perspective view showing a plasma display panel (PDP) according to a first exemplary embodiment of the invention, and FIG. 2 is a cross-sectional view taken along line II-II of FIG. 1.

Referring to FIG. 1 and FIG. 2, the PDP 20 has a first substrate (front substrate) 22 and a second substrate (rear substrate) 24. The front and rear substrates 22 and 24 may be made of glass, and they are arranged substantially in parallel with each other at a predetermined interval. Elements are arranged between the front and rear substrates 22 and 24 to generate an image according to the discharge mechanism.

That is, generally, barrier ribs 26, which define a discharge space, discharge sustain electrodes 28, which apply a voltage required for discharging, address electrodes 30, a fluorescent layer 32, dielectric layers 34 and 36, and a protective film 38 are arranged between the front and rear substrates 22 and 24.

The front and rear substrates 22 and 24 generally have rectangular shapes, each having long sides and short sides. A sealing material 40 is coated substantially along a periphery of at least one of the front and rear substrates 22 and 24, and the substrates are bonded to each other through a bonding process.

A space in the PDP 20 defined by the front and rear substrates 22 and 24 is generally maintained in a vacuum. The discharge space defined by the barrier ribs 26 is filled with a discharge gas.

To this end, an exhaust hole 24a may be formed on a corner of one substrate of the front and rear substrates 22 and 24. FIG. 1 shows the exhaust hole 24a formed in the upper left corner of the rear substrate 24. The exhaust tube 42 is arranged to communicate with the exhaust hole 24a.

In the present embodiment, the exhaust tube 42 is formed in a tip shape, and it has a substantially circular, hollow cross-section. One end of the exhaust tube 42 (the end facing the rear substrate 24) may be aligned with the exhaust hole 24a to communicate with the exhaust hole 24a and is coupled with the rear substrate 24. The other end of the exhaust tube 42 (the end away from the rear substrate 24) is sealed after an exhaust process and a discharge gas injection process. The exhaust tube 42 may be coupled with the rear substrate 24 by an adhesive, such as a sealing frit 41.

The exhaust tube 42 has a base 42a that is coupled with the rear substrate 24 and a plurality of hollow bodies 42b that are coupled with the base 42a. The end of the outermost hollow body of the plurality of hollow bodies is sealed.

Here, the hollow bodies 42b are separably coupled with one another. Thus, the respective hollow bodies 42b have predetermined lengths, and they are coupled with one another by an adhesive, such as a sealing frit 42c.

The sealing frit 42c may be made of a sealing frit material, such as urethane, excluding glass. In the invention, the hollow bodies 42b may be coupled with one another by other coupling mechanisms.

Here, the number of hollow bodies 42b is not limited to a specified number. For example, a proper number of hollow bodies 42b may be provided considering how many times the discharge gas is expected to be re-injected in the life span of the PDP 20.

Further, in the present embodiment, the hollow bodies 42b have a substantially circular cross-section, but the cross-sectional shape is not limited. For example, various shapes, such as a rectangle, an octagon, an oval, an ellipse, and the like, may be used.

As such, if the exhaust tube 42 has a multi-stage structure with the separably coupled hollow bodies 42b, when the discharge gas in the PDP 20 is replaced, the replacement may be easily performed without damaging the PDP 20.

A cap 52 covers and protects the exhaust tube 42. The cap may be detachably coupled with a chassis base 50, which supports the PDP 20.

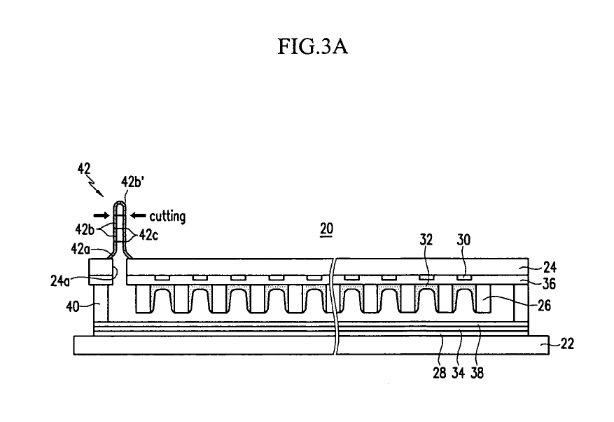

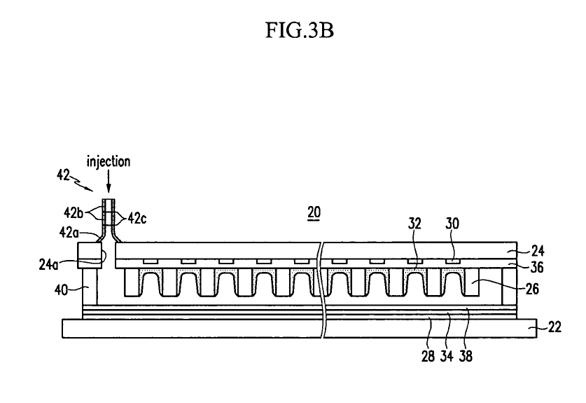

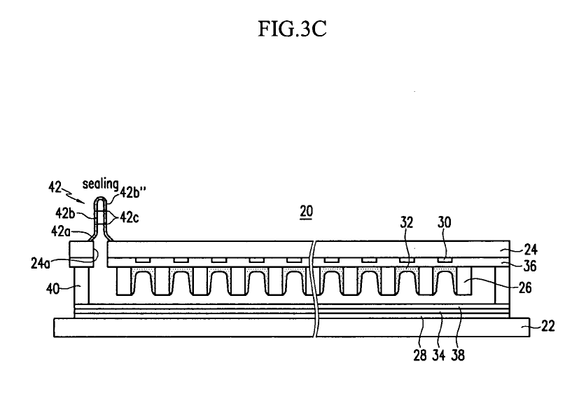

FIG. 3A, FIG. 3B and FIG. 3C are diagrams showing a process in which the discharge gas injected into the space in the PDP 20 is replaced through the exhaust tube 42.

When manufacturing the PDP 20, air in the PDP 20 is first exhausted through the exhaust tube 42, and then discharge gas is injected into the PDP 20. The end of the exhaust tube 42 may then be sealed. More specifically, the end of the last hollow body 42b′ of the plurality of hollow bodies 42b is sealed, thereby completing the PDP 20.

Referring to FIG. 3A, if it is determined that the discharge gas in the PDP 20 is contaminated, the last hollow body 42b′ is removed. For example, the last hollow body 42b′ may be removed by cutting where it is separably coupled with another hollow body 42b.

Referring to FIG. 3B, once the old discharge gas is exhausted, new discharge gas may be injected into the PDP 20 through the opening.

Next, referring to FIG. 3C, an end of the last hollow body 42b″ of the remaining hollow bodies 42b is sealed, thereby completing replacement of the discharge gas.

As such, in the present embodiment, since the exhaust tube 42 has the multi-stage structure, the hollow bodies 42b may be removed one by one to exhaust old discharge gas and inject new discharge gas as the occasion arises, thereby increasing the PDP's life span.

When a hollow body is removed to inject new discharge gas, cutting may be easily performed since the hollow bodies 42b are bonded to each other by the sealing frit 42c, which is made of a different material than the front and rear substrates 22 and 24. Further, the front and rear substrates 22 and 24 may be prevented from being cracked or damaged due to an impact at the time of cutting.

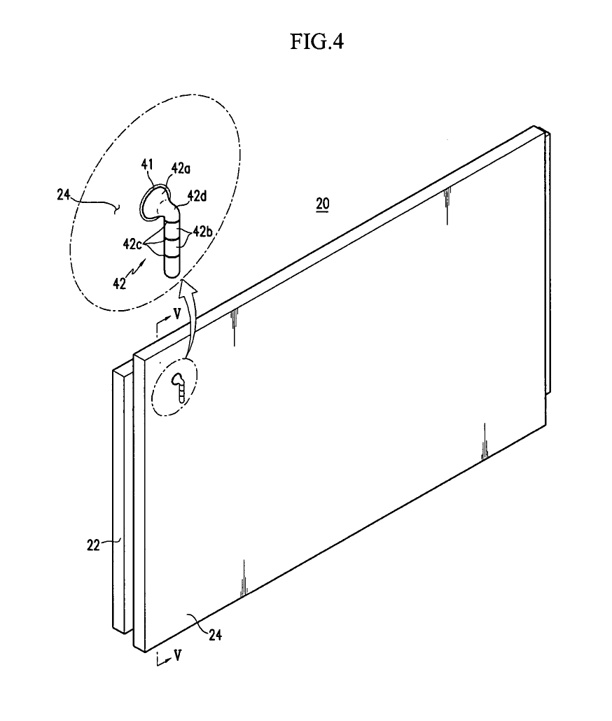

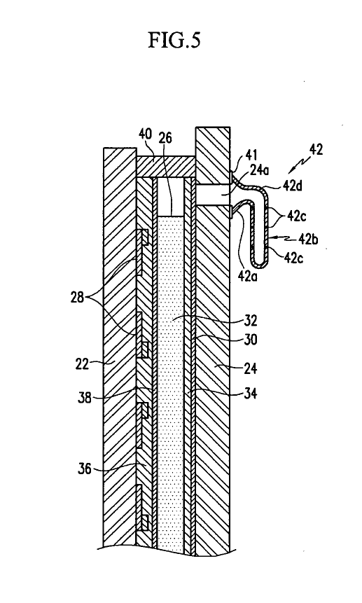

FIG. 4 is a rear perspective view showing a PDP according to a second exemplary embodiment of the invention. FIG. 5 is a cross-sectional view taken along line V-V of FIG. 4.

Referring to FIG. 4 and FIG. 5, an exhaust tube 42 has at least one curved hollow body 42d and at least one substantially linear hollow body 42b. The at least one linear hollow body 42b is coupled with the curved hollow body 42d and is arranged substantially parallel to the rear substrate 24.

Here, the hollow bodies 42b and 42d are separably coupled with one another. To this end, as described above, the hollow bodies 42b and 42d may be coupled with one another by other connecting mechanisms, in addition to a sealing frit 42c, which may be made of urethane, excluding glass.

In the present embodiment, the curved hollow body 42d is bent at approximately 90 degrees and communicates with an exhaust hole 24a. The linear hollow bodies 42b may be coupled with the curved hollow body 42d to be substantially parallel with the rear substrate 24.

Thus, as described above, the exhaust tube 42 may be arranged to be substantially parallel to the rear substrate 24. As apparent from FIG. 4 and FIG. 5, the exhaust tube 42 is arranged along the short side of the front and rear substrates 22 and 24.

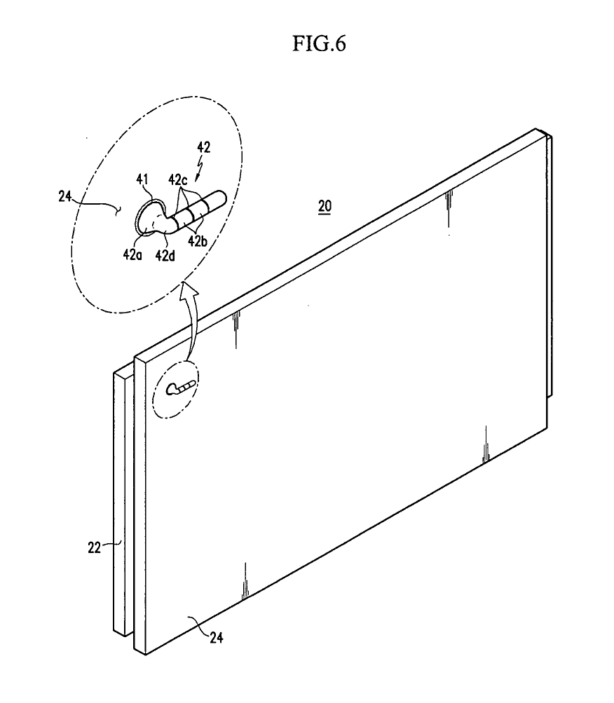

The exhaust tube 42 may be arranged in alternative directions. For example, as shown in FIG. 6, the exhaust tube 42 may be arranged along the long sides of the front and rear substrates 22 and 24. Further, though not shown, the exhaust tube 42 may be arranged in a diagonal direction of the front and rear substrates 22 and 24.

The curved hollow body 42d has a base 42a that is coupled with the rear substrate 24 by a sealing frit 41. The base 42a has maximum inside and outside diameters that are larger than maximum inside and outside diameters of each hollow body 42b, such that the curved hollow body 42d may be securely coupled with the rear substrate 24.

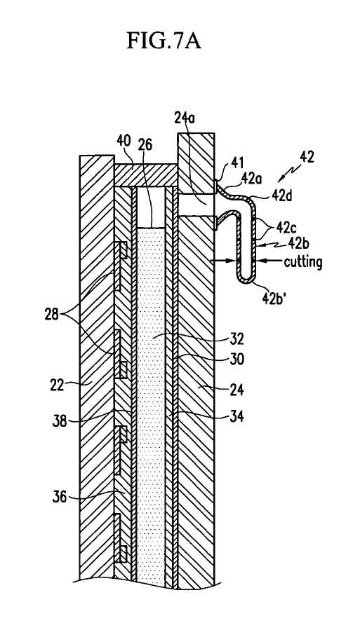

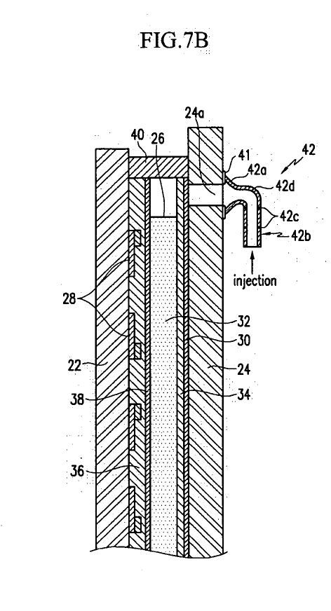

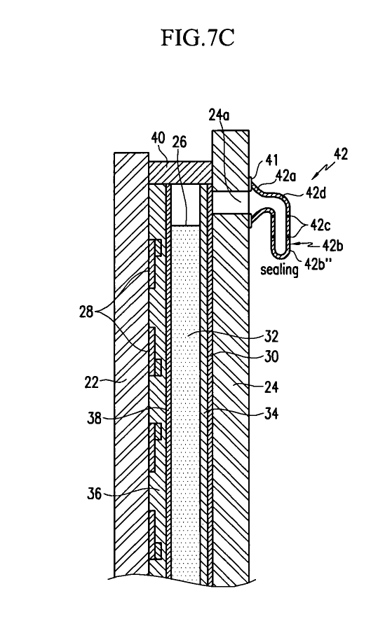

FIG. 7A, FIG. 7B and FIG. 7C are diagrams showing a case in which the exhaust tube according to the second exemplary embodiment is used.

Referring to FIG. 7A, FIG. 7B and FIG. 7C, the PDP's discharge gas may be replaced through the following processes. As described above with regard to the first embodiment, the last hollow body 42b′ is removed (see FIG. 7A), the old discharge gas is exhausted, new discharge gas is injected into the PDP 20 through the opened exhaust tube 42 (see FIG. 7B), and the end of the last linear hollow body 42b″ of the remaining hollow bodies 42b is sealed (see FIG. 7C). If the last linear hollow body 42b″ is removed, then the curved hollow body 42d may be sealed after injecting the new discharge gas.

As such, in the present embodiment, the exhaust tube 42 has a multi-stage structure, and the hollow bodies 42b may be removed one by one to exhaust the old discharge gas and inject new discharge gas as the occasion arises, thereby increasing the PDP's life span.

Further, the exhaust tube 42 bends at approximately a right angle to be arranged substantially parallel with the rear substrate 24. Hence, the amount of space occupied by the exhaust tube 42 in a direction perpendicular to the rear substrate 24 decreases, as compared to the case in which the exhaust tube is arranged at a right angle with respect to the rear substrate 24.

Therefore, when mounting a circuit board on the chassis base with the PDP 20 supported and provided thereon, the exhaust tube 42 may not interfere with the circuit board. Thus, the circuit board may be easily mounted on the chassis base. Further, the exhaust tube 42 itself may be prevented from being damaged. Additionally, it is possible to reduce the PDP's thickness.

As described above, a PDP according to exemplary embodiments of the invention has an improved exhaust tube structure that allows contaminated discharge gas to be easily replaced with new discharge gas and that prevents damage to the exhaust tube and PDP. As a result, the PDP's life span may be lengthened.

Further, the exhaust tube may be arranged substantially parallel to the rear substrate so that it does not project outwardly. Thus, interference may be prevented when combining the PDP and the chassis base to each other and when combining the chassis base and a circuit board to each other. As a result, the PDP may be more easily manufactured, without damaging the exhaust tube, and it may be made thinner.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel (PDP), comprising:
a first substrate and a second substrate that are sealed together; and
an exhaust tube comprising a plurality of separably coupled hollow bodies,
wherein the exhaust tube communicates with an exhaust hole formed in one substrate of the first substrate and the second substrate.

2. The PDP of claim 1, wherein a first hollow body arranged at a first end of the exhaust tube is coupled with the one substrate, and an end of a second hollow body arranged at a second end of the exhaust tube is sealed.

3. The PDP of claim 2, wherein the first hollow body is coupled with a base that is attached to the one substrate so as to cover the exhaust hole.

4. The PDP of claim 3, wherein the base has maximum inside and outside diameters that are larger than maximum inside and outside diameters of each hollow body.

5. The PDP of claim 1, wherein the exhaust tube is arranged substantially parallel to the one substrate.

6. The PDP of claim 5, wherein the hollow bodies comprise:
at least one curved hollow body; and
at least one linear hollow body that is coupled with the at least one curved hollow body.

7. The PDP of claim 6, wherein the at least one curved hollow body is coupled with the one substrate, the at least one linear hollow body is coupled with the at least one curved hollow body so as to serve as a last linear hollow body, and an end of the last linear hollow body is sealed.

8. The PDP of claim 7, wherein the at least one curved hollow body comprises a base that is attached to the one substrate so as to cover the exhaust hole.

9. The PDP of claim 8, wherein the base has maximum inside and outside diameters that are larger than maximum inside and outside diameters of each hollow body.

10. The PDP of claim 5, wherein the first substrate and the second substrate have substantially rectangular shapes, each substrate having a pair of short sides and a pair of long sides, and the exhaust tube is substantially arranged along the pair of short sides of the first substrate and the second substrate.

11. The PDP of claim 5, wherein the first substrate and the second substrate have substantially rectangular shapes, each substrate having a pair of short sides and a pair of long sides, and the exhaust tube is substantially arranged along the pair of long sides of the first substrate and the second substrate.

12. The PDP of claim 1, wherein the one substrate is a rear substrate of the plasma display panel.

13. The PDP of claim 12, further comprising:
a chassis base; and
a cap,
wherein the chassis base is coupled with a first side of the plasma display panel, and the cap is detachably provided on the chassis base so as to cover and protect the exhaust tube.

14. The PDP of claim 1, wherein the hollow bodies are separably coupled to one another by a sealing paste made of a material that does not include glass.

15. The PDP of claim 1, wherein each hollow body has a substantially circular cross-section.

16. An exhaust tube for a flat panel display, comprising:
a plurality of separably coupled hollow bodies.

17. The exhaust tube of claim 16, wherein the separably coupled hollow bodies comprise:
at least one curved hollow body; and
at least one liner hollow body,
wherein the at least one curved hollow body is attached to a substrate of the flat panel display, and the at least one linear hollow body is attached to the at least one curved hollow body and is substantially parallel to the substrate.

18. A method for replacing discharge gas of a display panel, comprising:
removing a hollow body from a plurality of separably coupled hollow bodies of an exhaust tube; and
exhausting the discharge gas within the display panel.

19. The method of claim 18, further comprising:
injecting discharge gas into the display panel; and
sealing the exhaust tube.

20. The method of claim 19, wherein sealing the exhaust tube comprises sealing a remaining separably coupled hollow body.

21. The method of claim 18, wherein removing the hollow body comprises cutting the exhaust tube at a portion where a sealer coupling the removed hollow body is located.
